(19) United States
(12) Patent Application Publication
(10) Pub. No.: US 2003/0196743 A1
(43) Pub. Date: Oct. 23, 2003

(54) Apparatus and methods for producing tow based patterns

(76) Inventors: Vincent Borbone, Sandown, NH (US); Shawn M. Walsh, Baltimore, MD (US); Vasilios Brachos, Lowell, MA (US)

Correspondence Address: C. Eric Schulman, Esq., Mintz, Levin, Cohn, Ferris,, Glovsky and Popeo, P.C., One Financial Center, Boston, MA, 02111, US

(21) Appl. No.: 10/124,323

(22) Filed: Apr. 17, 2002

(51) Int. Cl. B32B 31/00

(52) U.S. Cl. 156/180; 156/361; 156/441

(57) ABSTRACT

One embodiment of the invention provides an apparatus for producing a preform. The apparatus includes a lay-up device and a distribution head coupled to the lay-up device. The lay-up device receives tow. The lay-up device has a plurality of sockets. The sockets removably and replaceably engage pins along a perimeter of a desired preform shape. The distribution head distributes tow. The distribution head loops tow around the pins to form the preform.

### GOVERNMENT RIGHTS

This invention was made with government support under contract No. F33615-97-D-5009 issued by the Air Force. The Government has certain rights to this invention.

### FIELD OF THE INVENTION

The invention relates to the field of equipment and methods for the fabrication of composite structures and, more specifically, to equipment and methods for the fabrication of tow-based patterns.

### BACKGROUND OF THE INVENTION

The use of polymer composites continues to grow at approximately 11-14% per annum, largely driven by the aerospace industry and more recently by the sporting goods and private transportation industries. The desire for lightweight, environmentally safe and resilient vehicles and structural materials continues to stimulate this growth. One can generally divide composite processes into two categories: those processes involving pre-impregnated materials (prepreg) and those involving “wet” fabrication.

Prepreg involves the dispersal of a partially cured resin on a lamina of unidirectional or woven fiber material. In general prepregs consist of surface treated glass, graphite, or aramid fibers impregnated with 28-60 weight percent of a reactive and chemically complex thermoset resin formulation or a thermoplastic resin. Prepreg suppliers usually deliver prepreg material as a roll requiring refrigeration until a composite manufacturer needs the material. A composite structure manufacturer subsequently unrolls the material, cuts the material to size, and stacks the cut material to create the desired composite structure. The composite structure manufacturer uses an autoclave or heated press to supply the necessary heat and pressure for cure and consolidation.

By contrast, wet processes involve the use of “dry” fibers that, either as individual tows or woven fabrics, manufacturers infuse with resin as part of the manufacturing process. Wet processes advantageously eliminate the need for costly prepregs and provide the ability to use a variety of non-autoclave process operations. Wet processes include pultrusion, resin transfer molding (RTM), Vacuum assisted resin transfer molding (VARTM), compression molding and filament winding.

A typical wet process such as RTM or VARTM starts with the preparation of the preform. A preform manufacturer can manufacture a preform in several ways, but generally the manufacturer unrolls a fabric (either woven or non-crimped), cuts the fabric to shape, and stacks the desired number of plies in a tool to create a desired part. The manufacturer subsequently infuses the preform with resin, cures the preform, and removes the preform from the tool.

One can divide the major costs associated with RTM and VARTM into 3 basic areas: preforms, tooling, and resin infusion. While tooling can be expensive (especially in RTM), preform cost is typically the largest factor contributing to the overall end item cost of a composite article.

The typical preform process involves a considerable amount of labor and waste. Typically, one cuts the fabric to shape, resulting in scrap material for each and every ply. The fabric may be treated with binder material adding to labor and waste. The preform is then delivered to, and fitted within, a tool.

According to a conventional process, one manufactures a preform using either woven or non-crimp fabrics. There are a limited number of suppliers for such materials and, due to the degree of specialization required to make such materials, the costs of these “engineered” materials are often significant.

Benefits to designing with composites include the ability to align fibers to the load direction and the ability to use only the minimum required amount of material to accept expected loading conditions. Standard fabric styles often diminish these benefits. An engineer often has to incorporate combinations of standard fabrics to achieve a structure sufficient to support expected loads. The use of combined fabrics often leads to a finished part that is heavier than necessary and that requires more material than necessary. Using standard fabrics often causes higher manufacturing costs due to the additional layers required and associated high scrap rates. The additional layers result in higher material costs and create additional labor associated with cutting and positioning the additional layers.

Furthermore, low volume composite part production is a problem due to minimum order amounts of rolled fabric. Minimum order amounts commonly range from a full roll to pallets of rolls of woven or non-crimp fabric, Thus, minimum order amounts generally provide many times more material than required for a particular project. The minimum orders sometimes prevent the purchasing of the correct material, as a manufacturing budget will only allow the purchasing of a certain number of minimum orders.

U.S. Pat. No. 5,022,592, entitled “Fiber Placement Machine” and incorporated herein by reference in its entirety, relates to a machine capable of laying down a number of tows side-by-side onto a tool or form having a relatively complex shape. However, such devices require sophisticated hardware and software to generate preforms from tows. U.S. Pat. No. 4,735,672, entitled “Automated Fiber Lay-Up Machine” and incorporated herein by reference in its entirety, relates to an automated machine for laying up fibrous material. However, a need remains for simple systems and methods for creating designed performs inexpensively and with reduced waste. Furthermore, a need exists for systems and methods that allow for the creation of a wide-variety of preform designs without necessitating

### SUMMARY OF THE INVENTION

One version of the present invention provides apparatus and methods for creating preforms in-situ, using a supply of tow material instead of a fabric. This approach permits not only significant cost savings but also significant reduction in labor and waste associated with more traditional preforming methods. Furthermore, because embodiments of the invention use tow to build up a preform in-situ on a configurable lay-up device, these embodiments offer the ability to produce truly near-net shapes with unique fiber orientations.

These patterns may be combined with other patterns for preforming or used directly in a liquid molding process (e.g., resin transfer molding, vacuum assisted resin transfer molding, compression molding, etc.). Thus, the present invention provides the ability to go from fiber tow, which is less expensive and more versatile than fabric, to a (near) net-shape pattern or perform, bypassing processes such as weaving, stitching and fabric cutting and kitting.

One embodiment of the invention provides an apparatus for producing a preform. The apparatus includes a lay-up device and a distribution head coupled to the lay-up device. The lay-up device receives tow. The lay-up device has a plurality of sockets. The sockets removably and replaceably engage pins along a perimeter of a desired preform shape. The distribution head distributes tow. The distribution head loops tow around the pins to form the

Another embodiment of the invention provides a method for producing a preform. The method provides a lay-up device for receiving tow. The lay-up device has a plurality of sockets. The sockets removably and replaceably engage pins. The method provides a distribution head coupled to the lay-up device. The distribution head distributes tow. The method then places pins in sockets along a perimeter of a desired preform shape and uses the distribution head to loop tow around the pins to form the preform.

### BRIEF DESCRIPTION OF DRAWINGS

For a better understanding of the present invention, reference is made to the drawings, which are incorporated by reference and in which:

FIG. 1 is a perspective view of one embodiment of a tow-based preform manufacturing apparatus according to the present invention;

FIG. 2 illustrates a roll of fabric for use in existing preform processes;

FIG. 3 illustrates steps in a process of manufacturing a preform using existing techniques;

FIG. 4 illustrates a portion of the apparatus of FIG. 1, including pins engaged with selected sockets to form an irregular shaped preform perimeter;

FIG. 5 is a schematic illustration of the distribution head of FIG. 1 distributing tow in a pattern partially defined by the preform perimeter of FIG. 4;

FIG. 6 illustrates a desired preform pattern for production by the apparatus of FIG. 1 and a tow path for obtaining the desired pattern using the apparatus of FIG. 1;

FIG. 7 illustrates two stages in the manufacture of a preform using the apparatus of FIG. 1;

FIG. 8A illustrates one embodiment of a cutting tool for use with the apparatus of FIG. 1;

FIG. 8B illustrates another embodiment of a cutting tool for use with the apparatus of FIG. 1;

FIG. 9 is a flow chart for one embodiment of a method according to the present invention;

FIG. 10 is an alternative embodiment of the lay-up device of FIG. 1;

FIG. 11 is an illustration of an embodiment of the lay-up device of FIG. 1 illustrating sockets and pins; and

FIG. 12 is another alternative embodiment of the lay-up device of FIG. 1.

### DETAILED DESCRIPTION OF THE INVENTION

The present invention provides systems and methods capable of creating inexpensive, custom, complex, tow-based patterns at a variety of volumes with low scrap rates. Manufacturers can use the patterns to form a complete part laminate or they can combine one or more patterns with one or more other patterns to create a complete part laminate. Manufacturers can use a pattern or group of patterns, produced using embodiments of the invention, in a liquid molding process to obtain a molded part. The liquid molding process can be one of a variety of liquid molding processes such as RTM, VARTM, or Compression

For present purposes, the term “tow” means a loose untwisted rope of filaments, which may include graphite, glass, aramid or other filaments, for use in reinforcement of plastic composite parts. The term “tow” includes yarns, which are multiple tows.

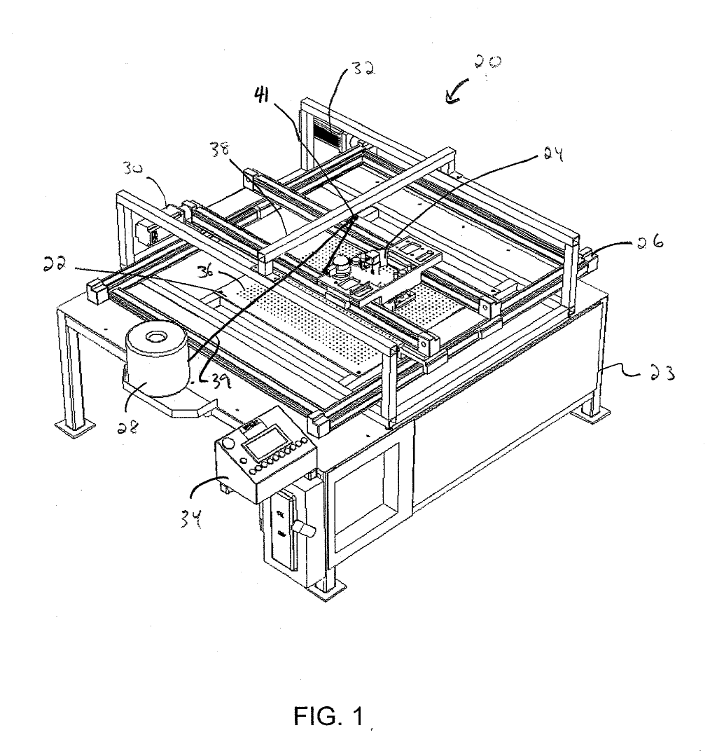

With reference to FIG. 1, one embodiment of the present invention provides apparatus 20 for producing tow-based patterns. Apparatus 20 includes a support structure 23 supporting an X-Y gantry 26, such as a XY gantry available from Macron Dynamics of Horsham, Pa. Two servo motors and one multi-axis controller such as the MX-2000 by Superior Electric of Bristol, Conn. drive the X-Y gantry. The X-Y gantry can be a conventional XY gantry such as the XY gantry described in U.S. Pat. No. 4,735,672, entitled “Automated Fiber Lay-Up Machine” and incorporated herein by reference in its entirety.

The XY gantry 26 supports a tow distribution head 24. A first motor 30 moves the distribution head 24 along a first direction, e.g., along the X axis, and a second motor 32 moves the distribution head 24 along a second direction, e.g., along the Y axis. Thus, the illustrated embodiment of the XY gantry provides independent dual axis motion. Although the illustrated embodiment includes an XY gantry for moving the tow distribution head in relation to the lay-up device, the present invention contemplates a variety of devices known in the art for moving a distribution head over a lay-up device such as a programmable robot.

Support structure 23 supports a spool 28, a control device 34, and a lay-up device 22. Spool 28 supplies tow 39 to distribution head 24 for laying tow onto lay-up device 22. Spool 28 supplies tow 39 through a tow-guide 41 located on a cross bar 38. The control device 34 is a conventional control device and allows a user to interact with apparatus 20 in a conventional manner.

In the illustrated embodiment, the lay-up device 22 includes sockets 36 for receiving pins. In this embodiment, the sockets form a grid. The spacing between adjacent sockets is preferably between about 1/32 of an inch to about 1 inch and, more preferably, between about 1/16 of an inch to about ½ of an inch. The distribution head 24 loops tow 39 around pins placed in selected sockets to form a preform.

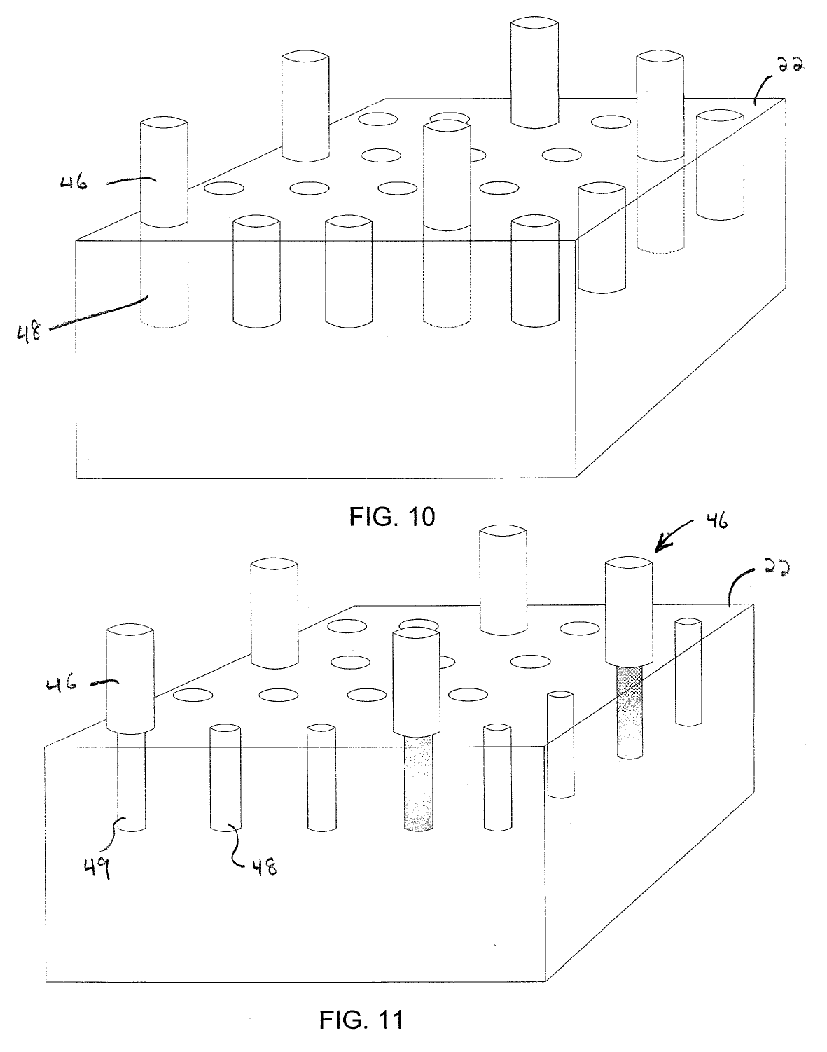

With reference to FIGS. 1 and 11, the pins 46 extend above the lay-up device 22 a sufficient distance to hold at least one layer of tow and preferably to hold multiple layers of tow. Conversely, the pins 46 should not extend too far above the lay-up device so as to interfere with the operation of the distribution head 24. Thus, the pins 46 preferably extend above the lay-up device from about 3/16 of an inch to about 1 and ½ inches and more preferably from about 3/16 of an inch to about 1 inch. Although the illustrated embodiment shows the lay-up device 22 having sockets arranged in a grid, the invention contemplates a variety of lay-up device configurations, as described further below with reference to FIG. 10.

With reference to FIGS. 8A and 8B, one embodiment of the distribution head 24 includes a body 57, and a flber-laying nozzle 60 coupled to the body 57 via a fiber laying nozzle Z-axis motion mechanism 58. Embodiments of the distribution head can further include a device 50 for automatically placing pins on the lay-up device, and a laser cuffing device 42 or a blade cuffing device 44.

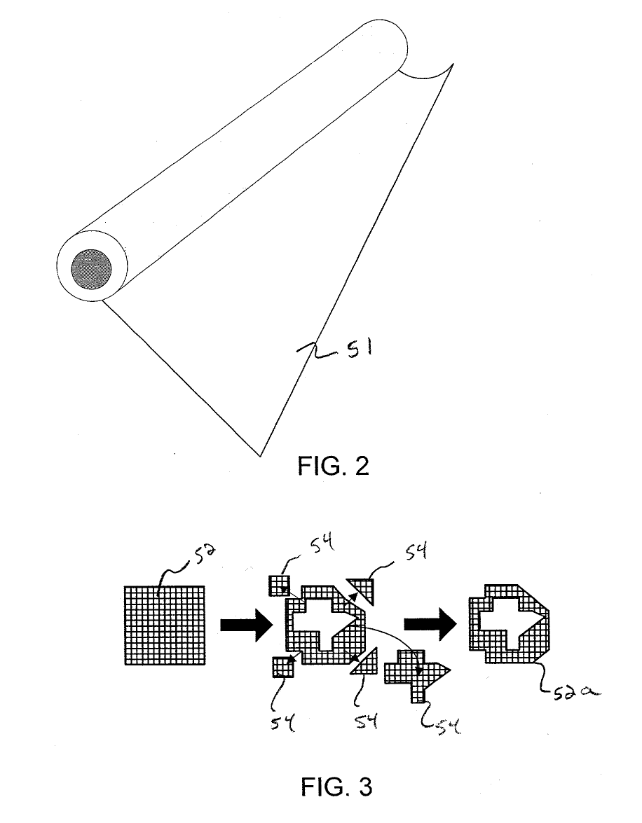

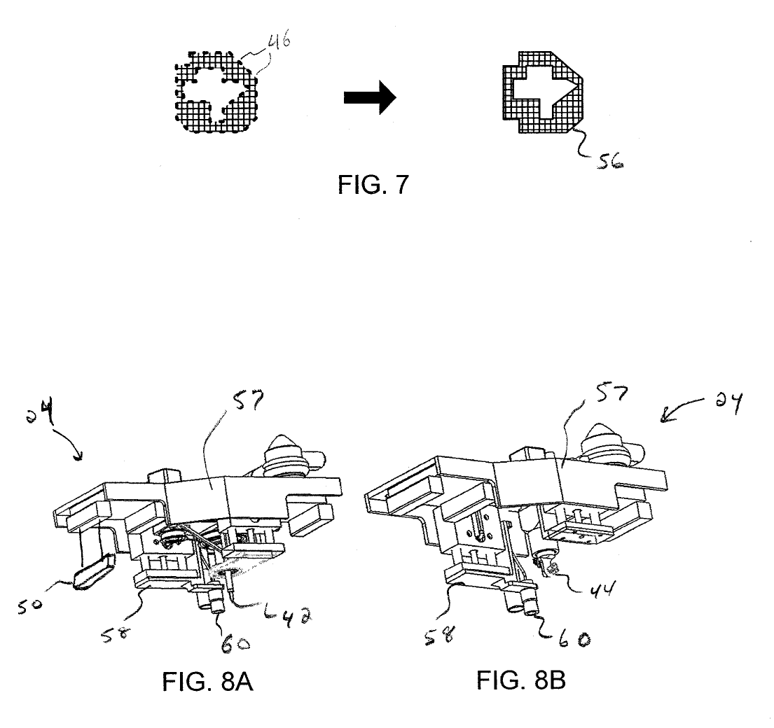

FIGS. 3 and 7 provide schematics of a conventional preform process and one embodiment of a process according to the present invention, respectively. In a conventional preform process, a manufacturer begins the process by cuffing an appropriately sized ply of fabric 52, as shown in FIG. 3, from a roll of fabric 51, as shown in FIG. 2. With reference to FIG. 3, cut-outs and shapes with irregular edges result in the need to cut each and every ply to shape. The need to cut each ply to shape generates waste that is proportional to the level of detail required by the ply design. Thus, as illustrated in FIG. 3, a manufacturer cuts scraps 54 from ply 52 to create shaped or designed ply 52a. By contrast, embodiments of the present invention use a series of pins 46 (as shown in FIG. 7) to ensure an inexpensive but effective means for achieving a desired shape without excessive cuffing.

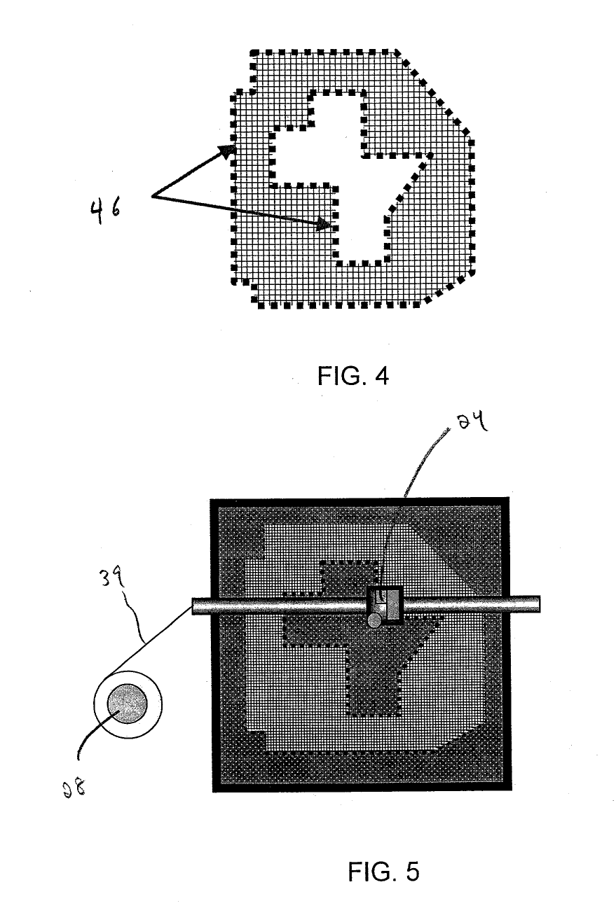

With reference to FIGS. 1, and 4, in one embodiment, a preform designer selects the placement of pins 46 in selected sockets 36 on a lay-up device 22 in accordance with a particular design. As shown in FIGS. 1 and 5, spool 28 continuously supplies tow 39 to a distribution head 24, which is mounted on a lay-up device 22, e.g., an X-Y table. The head 24 distributes tow 39 in any direction given the independent dual axis motion of the XY gantry. The invention contemplates placement of the spool of tow 28 anywhere on the equipment including on the distribution head 24.

As noted above, one embodiment of the lay-up device 22 contains an array of sockets 36 for receiving pins. An operator can manually insert pins in accordance with a particular design or apparatus 20, e.g., a device 50 (shown in FIG. 8) on the distribution head 24, can insert pins automatically in accordance with a particular design. One embodiment, of software that the system can use to translate a design into movements of the distribution head and for placement of pins by device 50 utilizes as a base CAD-to-Motion software such as software provided by Superior Electric of Bristol, Conn. In one embodiment additions to the software can be made to accommodate culling blade rotation to align the culling blade with the direction of cut. Thus, for example, placing pins along the interior and exterior perimeter of a desired preform and then looping tow around the pins leads to the near net production of irregularly shaped preforms containing cut-outs. A laminate design predetermines the direction and amount of tow that apparatus 20 places on lay-up device 22. Thus, a method according to one embodiment includes pre-programming the direction and amount of tow into the system or apparatus 20.

With reference to FIGS. 1 and 8, embodiments of the system 20 can place several layers of tow on lay-up device 22 in one session, i.e., with the same pin configuration, by raising the fiber laying nozzle 60 a specified distance in the Z direction between laying down different layers The fiber laying nozzle Z axis motion device 58 effects the change in height of the fiber laying nozzle 60.

Embodiments of the process can further include using simple preform stabilization techniques, such as binder or stitching, to hold layers of tow together. Finally, embodiments of the system 20 can trim the tow to separate the tow from the pins in order to remove the preform from the table and to create the final net-shape pattern. Alternatively, an operator can perform the trimming step manually.

Thus, embodiments of the present invention create patterns from tow. The apparatus 20 creates patterns by looping tow around pins that are configured so as to be located around the perimeter of a desired preform shape. If required, embodiments of apparatus 20 can then post trim the resulting preform to separate the preform from the pins on the lay-up device 22.

Programming a dual axis X-Y gantry achieves the placement of the tow. By programming the XY gantry 26, the tow distribution head 24 follows a predetermined path. In this manner, the distribution head according to one embodiment places tow along an entire path sufficient to make a desired preform. The tow path travels to the outside perimeter of the desired pattern and, by appropriately designing the placement of pins, the tow passes in desired directions.

Placement of the pins defines the near net-shape edge of the pattern and facilitates alignment of various spans of the tow. The load direction dictates the fiber/tow direction based on structural analysis and design of the final part. However, the presence of a multitude of pins allows the designer flexibility to utilize any possible orientation for the fibers in the pattern design. Thus, a designer can provide instructions to the software, e.g., the CAD-to-motion software, that controls the distribution head so as to align fibers along a load direction.

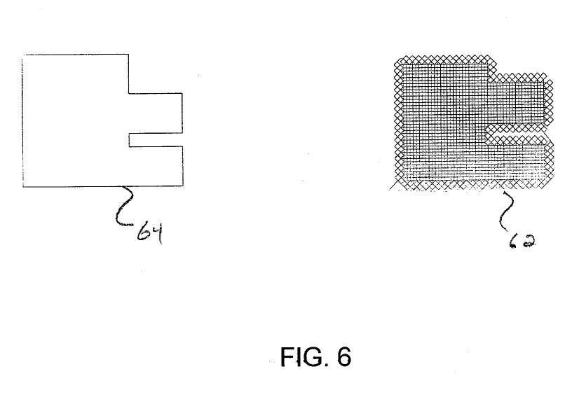

As noted above, a third axis (Z-axis) can be utilized on the tow placement head in order to make thick preform patterns or three-dimensional (3D) patterns. Accordingly, in this embodiment, the fiber laying nozzle 60 elevates every time the apparatus 20 completes a layer of tow. The programmed path, based on the number of layers and fiber directions, creates the tow path. With ref to FIG. 6, the tow path 62 creates the pattern 64.

One embodiment of a method according to the present invention includes stabilizing the preform after placing the tow(s). Typically, the patterns need only enough stabilization to maintain the pattern geometry until the manufacturer places the pattern into a liquid molding process or into a preform station that turns the patterns into a 3-D preform shape. The preform method according to the present invention can achieve stabilization by a variety of methods including: (1) using thermoplastic or thermoset powdered binder, sprayed adhesives or tackifiers, or extruded thermoplastic binder, (2) dipping the tow through a binder or a tackifier prior to placement, or (3) stitching the layers together. When the preform method uses binder as a stabilization technique, the method can additionally use a heat source such as an IR heater assembly to stabilize the pattern. Furthermore, one embodiment of the method of the present invention can use pressure during cooling to optimize the consolidation of the pattern. The method can achieve the cooling of the patterns by using forced air or by dragging a cold tool over the patterns.

As noted above, one embodiment of the method of the present invention post cuts the stabilized pattern. The method can achieve the post cuffing as part of an automated cycle. The method can use a variety of cuffing tools including an ultrasonic cuffing system as shown in FIG. 8A, a laser cutting system, or a blade cuffing system, e.g., a pinch rolling system as shown in FIG. 8B.

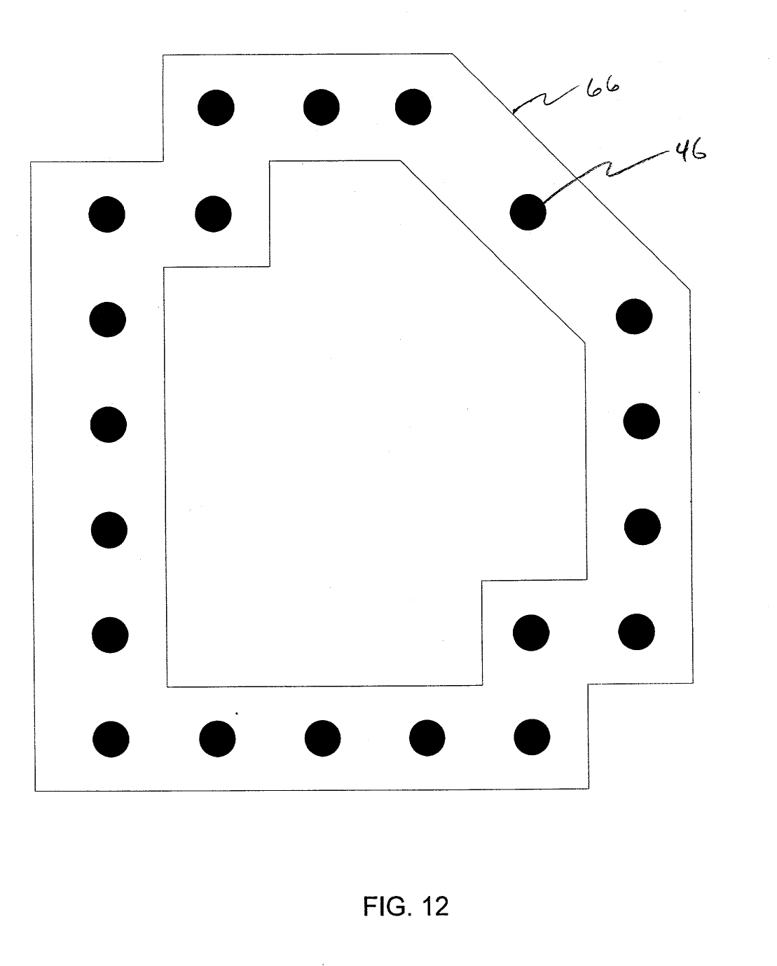

Although the embodiment illustrated in FIGS. 1 and 11 shows lay-up device 22 having sockets for receiving the portions 49 of pins 46 and the sockets arranged in a grid, the invention contemplates a variety of lay-up device configurations. With reference to FIG. 10, an example of another lay-up device configuration includes pins 46 slidably engaged within slots 48 such that either an operator or apparatus 20 can push selected pins up out of the slots 48 to arrange the pins along the perimeter of a desired preform. With reference to FIG. 12, another lay-up device configuration includes a plurality of premade bases 66 having pins 46 arranged in preselected patterns. Embodiments of the present invention design the bases to be removably and replaceably affixable to support structure 23. Thus, an operator can merely replace one base 66 with another to create different preforms or to create different layers of a preform.

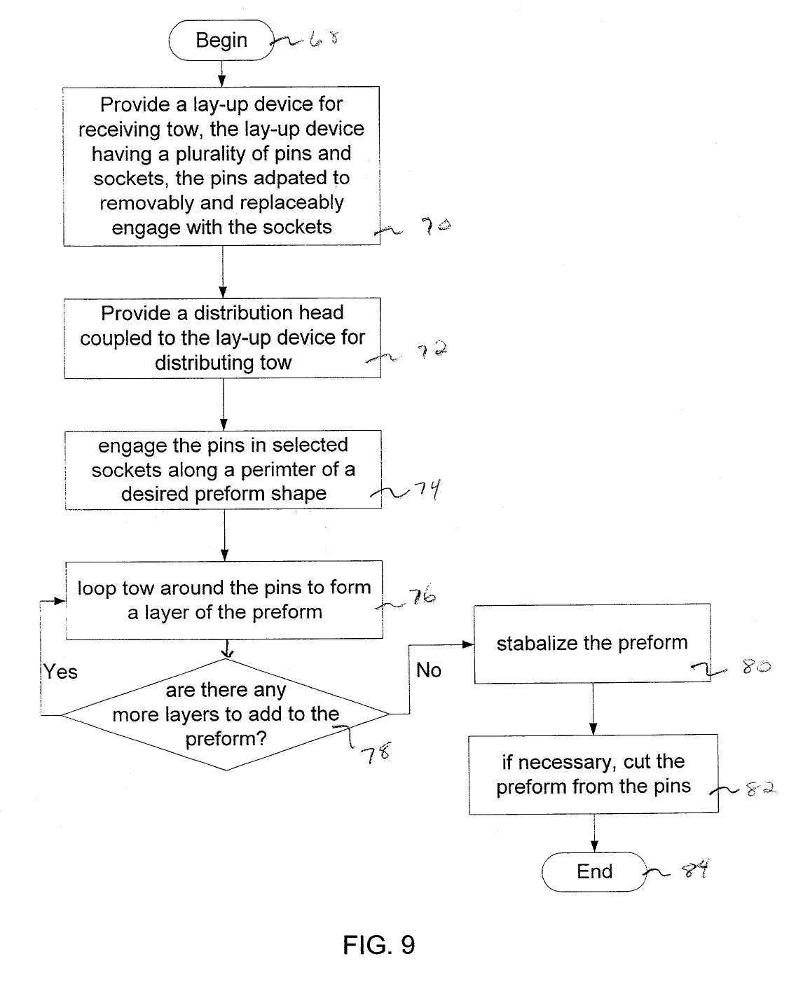

FIG. 9 illustrates one embodiment of a method according to the invention. The method begins 68 and provides 70 a lay-up device for receiving tow. As noted above, in one embodiment, the lay-up device has a plurality of pins and sockets. The pins removably and replaceably engage with the sockets. The method then provides 72 a distribution head coupled to the lay-up device for distributing tow. The method engages 74 the pins in selected sockets along a perimeter of a desired perform shape. The method loops 76 tow around the pins to form a layer of the perform. The method then determines 78 if there are any more layers to add to the perform. If so, the method returns to step 76. If not, the method may optionally stabilize 80 the perform. The method may include cutting 82 the perform from the pins at which point the method terminates 84.

Typical products produced by the present invention may include structural, semi-structural and cosmetic composite parts for all composite industries such as the marine industry, the automotive industry, and the aerospace industry.

This invention produces net shape patterns from tow, the most inexpensive form of reinforcing materials. It allows patterns to be created with any weight, any fiber direction, balanced or unbalanced, and it allows local reinforcements within a pattern. An unbalanced laminate is a laminate that does not adjust for thermal strain induced by processing and may include a variety of reinforcement materials with different thermal and mechanical properties. This invention allows composite part manufacturers to produce these patterns or preforms as an alternative to purchasing rolls of fabric and cutting the necessary patterns. Thus, the present invention allows for lower scrap rates and greater flexibility in pattern design. Embodiments of the present invention can provide completed 2-D or 3-D preforms or patterns for use with a preforming process such as the process used in the Solectria Diaphorm™ system available from Solectria Corporation of Woburn, Mass.

Having thus described illustrative embodiments of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. An apparatus for producing a preform, said apparatus comprising:
a lay-up device for receiving tow, said lay-up device having a plurality of sockets, the sockets adapted to removably and replaceably engage pins along a perimeter of a desired preform shape; and
a distribution head for distributing tow, the distribution head coupled to the lay-up device, the distribution head adapted to loop tow around the pins to form the preform.

2. The apparatus of claim 1, wherein the lay-up device includes an X-Y table.

3. The apparatus of claim 2, wherein the lay-up device further includes the pins.

4. The apparatus of claim 3, wherein the apparatus further includes means for automatically configuring the pins in the plurality of sockets.

5. The apparatus of claim 3, wherein the pins extend above the X-Y table a distance of between about 3/16 of an inch and about 1 inch.

6. The apparatus of claim 1, wherein the sockets are arranged in a grid.

7. The apparatus of claim 6, wherein the spacing between adjacent sockets is between about 1/16 of an inch to about ½ of an inch.

8. The apparatus of claim 2, wherein the apparatus further comprises
a XY gantry coupled to the lay-up device and supporting the distribution head, the XY gantry having independent dual axis motion means for allowing the distribution head to distribute tow in any direction substantially within a plane defined by the X-Y table.

9. The apparatus of claim 8, wherein the distribution head further comprises
a fiber laying nozzle for laying fiber onto the lay-up device; and
fiber laying nozzle Z-axis motion means coupled to the fiber laying nozzle for changing the height over the X-Y table at which the fiber laying nozzle distributes tow.

10. A method for producing a preform comprising:
providing a lay-up device for receiving tow, the lay-up device having a plurality of sockets, the sockets adapted to removably and replaceably engage pins;
providing a distribution head for distributing tow, the distribution head coupled to the lay-up device,
placing pins in sockets along a perimeter of a desired preform shape; and
using the distribution head to loop tow around the pins to form the preform.

11. The method of claim 10, wherein the lay-up device includes an X-Y table and wherein placing pins in sockets along the perimeter of a desired preform shape includes placing pins in sockets along an exterior perimeter of a desired preform shape.

12. The method of claim 11, wherein placing pins in sockets along the perimeter of a desired preform shape includes placing pins in sockets along an interior perimeter of a desired preform shape.

13. The method of claim 10, wherein the method further comprises
placing several layers of tow around the pins on the X-Y table; and
holding the layers together using a preform stabilization technique.

14. The method of claim 13, wherein the preform stabilization technique uses at least one of a spray tackifier, an extruded binder commingled with fiber, and fiber pre-treated with binder.

15. The method of claim 13, wherein the preform stabilization technique uses stitching.

16. The method of claim 10, wherein the method further includes cuffing the preform away from the pins after looping the tow around the pins to form the preform.

17. The method of claim 16, wherein a cuffing tool performs the cutting, the cutting tool selected from the group consisting of an ultrasonic cuffing system, a laser cuffing system, and a cutting blade system.

18. The method of claim 10, wherein the method further comprises
providing a distribution head control means coupled to the distribution head for controlling the direction along which the distribution head distributes tow and wherein said distribution head is programmable, and
programming the distribution head control means to cause the distribution head to align fibers to an anticipated load direction of the preform.

19. An apparatus for producing a preform, said apparatus comprising:
a lay-up device for receiving tow, the lay-up device having pin configuration means for allowing the configuration of pins on the lay-up device in a plurality of patterns; and
distribution head means for distributing tow, the distribution head means coupled to the lay-up device, such that, upon the configuration of pins on the lay-up device along a perimeter of a desired preform shape, the distribution head can loop tow around the pins to form the preform.

20. The apparatus of claim 19, wherein the pin configuration means includes sockets.

21. The apparatus of claim 19, wherein the pin configuration means includes pins slidably engaged within slots.
